(19) United States
(12) Patent Application Publication
(10) Pub. No.: US 2002/0088292 A1
(43) Pub. Date: Jul. 11, 2002

(54) Actuation mechanism

(76) Inventors: Reinhard Berger, Buhl (DE); Norbert Esly, Buhl (DE); Julian Buckler, Birmingham (GB)

Correspondence Address: Alfred J. Mangels, 4729 Cornell Road, Cincinnati, OH, 45241-2433, US

(21) Appl. No.: 10/010,948

(22) Filed: Dec. 6, 2001

(30) Foreign Application Priority Data
Dec. 7, 2000 (DE) 100 60 700.4

(51) Int. Cl. F16D 28/00

(52) U.S. Cl. 74/422; 74/473.12

(57) ABSTRACT

An actuator for actuating an element of an automated clutch or of an automated transmission in a motor vehicle. The actuator includes a housing that receives a toothed rack and a gear that meshingly engages with the toothed rack. An electric motor is drivingly connected with the gear for shifting the position of the toothed rack relative to the housing. The actuator is spring biased in a predetermined direction by a spring that extends between a point on the toothed rack and a point on the housing. The electric motor and the gear can be fastened to the housing as preassembled unit.

### BACKGROUND OF THE INVENTION

1. Field of the Invention

The present invention relates to an actuation mechanism for the automated actuation of a clutch or a transmission in the drive train of a motor vehicle.

2. Description of the Related Art

Actuating devices of this type are known in the art from German Patent Publication No. DE 195 04 847. Due to their very large size, they need a relatively large space. But the space available in today's vehicles for arranging devices or assemblies is very limited, and because of an ever-increasing number of functions and features in today's motor vehicles, any existing space is divided among an ever-increasing number of devices.

An object of the present invention is therefore to provide a device that is smaller with respect to space requirements and yet, in view of functionality and longevity but also operating speed and actuating force, is as good as or better than the state-of-the-art devices.

### SUMMARY OF THE INVENTION

In accordance with the invention, that object is achieved in a device for actuating an automated clutch or an automated transmission by providing a housing that has an axially-extending receptacle for receiving a toothed rack, whereby, further, a receptacle is provided in which a gear engages and meshes with the toothed rack, whereby the gear can be driven by an electric motor through a transmission, and the electric motor together with the transmission and the gear can be fastened to the housing as a pre-assembled unit.

It is useful if the toothed rack is formed substantially as a cylinder and the receptacle for the toothed rack is formed substantially as a hollow cylinder.

It is also useful, furthermore, to provide an energy accumulator, such as a spring that is linked on one side, such as at an end area of the spring, to the toothed rack, and on the other side, such as at another end area of the spring, to the housing in the area of the hollow cylinder, wherein the toothed rack is movable in one portion of its longitudinal motion in a movement direction that is opposite to the force of the energy accumulator, and in another movement direction it is movable by the assistance of the energy accumulator.

It is advantageous if the energy accumulator is linked to the toothed rack by way of a protruding element.

It is also useful if the protruding element is at least a protruding catch, or a protruding ring, or a protruding edge of the housing.

It can be useful, in this context, if the protruding element is integrally formed with the toothed rack, or if it is formed in multiple pieces and then connected to the toothed rack.

It is also useful if the energy accumulator is linked to the housing by way of a protruding element.

Moreover, it is useful if the protruding element is at least a protruding catch or a protruding ring.

Likewise, in accordance with the invention, it can be useful if the protruding element is integrally formed with the housing, or if it is formed in multiple pieces with the housing and then connected to the housing.

In accordance with the invention, it is also useful if the connection is effected by an interlocking, a frictional locking, a force locking, or a material locking connection.

It is advantageous if the toothed rack is positioned in the receptacle of the housing for axial displacement, whereby its orientation is effected by two bearings that are each arranged, at a respective end area of the hollow-cylindrical receptacle. It can thereby be useful if the bearings are formed as bearing rings that can be inserted in the hollow-cylindrical receptacle and can be axially fixed. The axial fixation can be effected in one direction on a circumferential edge, or at least on a protrusion of the housing, whereby the axial fixation in the other direction is achieved by way of a retaining ring or snap ring that can be inserted in a groove.

It is also useful if one bearing ring serves as a bearing surface for the energy accumulator in the area of the housing.

### BRIEF DESCRIPTION OF THE DRAWINGS

The invention will be explained in more detail in the following description with the help of the embodiments that are represented in the drawing figures, in which:

FIG. 1 is an exploded side view showing a device in accordance with the invention; and

FIG. 2 is a bottom view, partially in section, of the device shown in FIG. 1.

### DESCRIPTION OF THE PREFERRED EMBODIMENTS

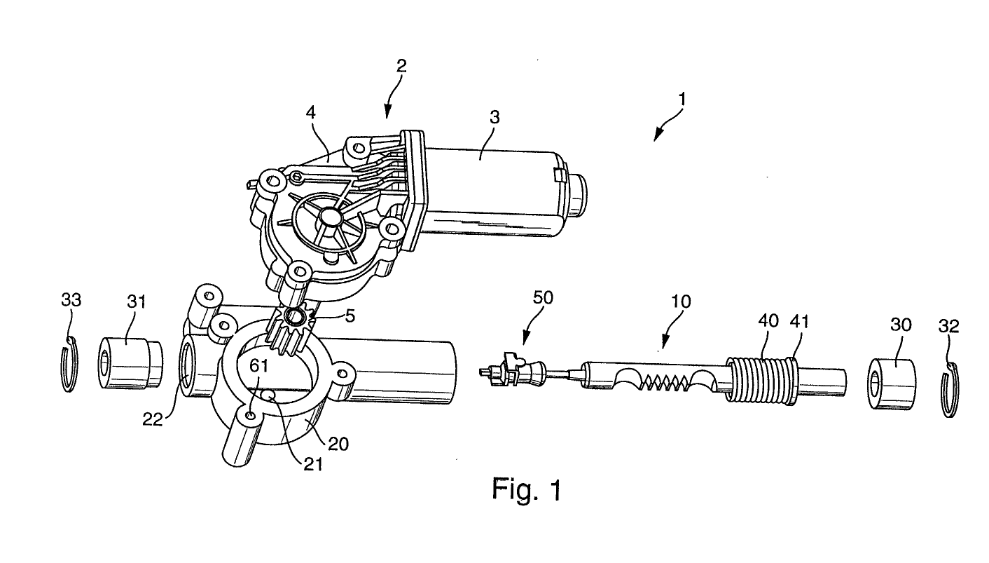

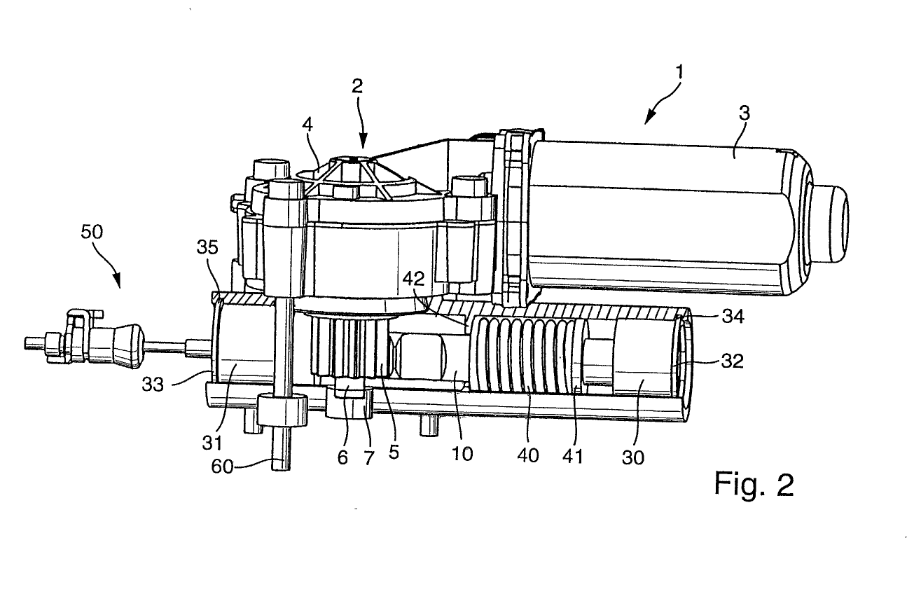

FIGS. 1 and 2 show a device 1 with a pre-assembled unit 2 that is essentially composed of an electric motor 3 that has a transmission coupled at its output side. The transmission is positioned within a transmission housing 4 and includes, for example, a worm gear pair (not shown), that includes a worm and a worm gear, whereby the worm is carried by the motor shaft and meshes with the worm gear. A further gear 5 is coupled with the worm gear and meshes with the toothed rack 10 of the device. Gear 5 is thereby rotated by electric motor 3 when the motor is actuated by a control unit (not shown). Gear 5 is carried on an axle that is supported in a receptacle 21 inside a housing 20.

Housing 20 has an axially-extending, hollow-cylindrical receptacle 22 that is open at each of its two end areas. Toothed rack 10 is inserted into receptacle 22 and is axially movable therewithin. Moreover, housing 20 includes a portion of receptacle 22 into which gear 5 extends when motor 3 is connected with housing 20 as a pre-assembled unit 2. Toothed rack 10 then meshes with gear 5, whereby upon rotation of gear 5 toothed rack 10 moves in the axial direction. Gear 5 is located on an axle or on a shaft 6, and it is rotatable with the axle or relative to it. Axle or shaft 6 is supported inside housing 20 by way of a retainer 7 and is supported by it.

Bearings 30 and 31 are provided for supporting and centering toothed rack 10 within receptacle 22. Those bearings can advantageously be provided as journal bearings or as rolling bearings that in each case can fit at an end of housing 20 against a circumferential ridge within receptacle 22. A pair of retaining rings 32, 33 can be provided to axially secure the bearings in place. The retaining rings can be received as snap rings in a respective groove 34, 35, within receptacle 22 of housing 20. The bearings are thereby axially retained, and by matching the outer diameter of the bearings with the inner diameter of receptacle 22 the bearings are also radially fixed.

An energy accumulator 40 is arranged coaxially with toothed rack 10 and can be supported at one end by a protruding element 41 on the toothed rack, and on the other end by a protruding element 42 within receptacle 22. The protruding elements 41, 42 can be integrally formed with the toothed rack or the receptacle, respectively, or they can be connected with them in several pieces. It is useful if protruding element 41 is formed as a circumferential ridge and integrally with toothed rack 10. It is also particularly useful if the projection 42 is formed as a ridge and integrally with receptacle 22.

Element 50 represents a connecting element for connection with a release element of a clutch.

The actuator can be manufactured in an advantageous way if the axis of the toothed rack is arranged parallel with the axis of the electric motor. In other applications, it can also be useful for those two axes not to be parallel, but instead at a predetermined angle.

Furthermore, screwed connections can be provided between the electric motor and the housing by screws 60 and threaded openings 61.

The claims included in the application are illustrative and are without prejudice to acquiring wider patent protection. The applicant reserves the right to claim additional combinations of features disclosed in the specification and/or drawings.

The references contained in the dependent claims point to further developments of the object of the main claim by means of the features of the particular claim; they are not to be construed as a waiver of independent, objective protection for the combinations of features of the related dependent claims.

Although the subject matter of the dependent claims can constitute separate and independent inventions in the light of the state of the art on the priority date, the applicants reserve the right to make them the subject of independent claims or separate statements. They can, moreover, also embody independent inventions that can be produced from the independent developments of the subject matter of the included dependent claims.

The exemplary embodiments are not to be considered to be limitations of the invention. On the contrary, many changes and variations are possible within the scope of the invention in the existing disclosure, in particular such variants, elements, and combinations and/or materials which, for example, are inventive by combining or modifying single features that are in combination and are described individually in relation to the general specification and embodiments as well as the claims and shown in the drawings, as well as elements or method steps that can be derived by a person skilled in the art in the light of the disclosed solutions of the problem, and which by means of combined features lead to a new object or new method steps or sequences of method steps, as well as manufacturing, testing, and operational procedures.

What is claimed is:

1. An actuator for actuating an automatic clutch or an automatic transmission, said actuator comprising: a housing that includes an axially-extending first receptacle for slidably receiving a toothed rack, and a second receptacle adjacent to the first receptacle and within which a gear is rotatably carried, wherein the gear is in meshing engagement with the toothed rack, and an electric motor drivingly connected with the gear, wherein the electric motor and the gear are provided as a pre-assembled unit and are connected with the housing.

2. An actuator as claimed in claim 1, wherein the toothed rack is substantially cylindrical, and the first receptacle is substantially a hollow cylinder.

3. An actuator as claimed in claim 1, including an energy accumulator positioned between and in contact with the toothed rack and the housing, and wherein the toothed rack is movable in a first direction of movement that is opposite to a force imposed on the toothed rack by the energy accumulator, and is movable in a second direction by the force of the energy accumulator.

4. An actuator as claimed in claim 3 wherein the energy accumulator contacts the toothed rack at a first protrusion extending outwardly from the toothed rack.

5. An actuator as claimed in claim 4, wherein the first protrusion is a protruding ring.

6. An actuator as claimed in claim 4, wherein the first protrusion is integrally formed with the toothed rack.

7. An actuator as claimed in claim 3, wherein the energy accumulator contacts the housing at an inwardly-extending second protrusion within the housing.

8. An actuator as claimed in claim 7, wherein the second protrusion is a protruding ring.

9. An actuator as claimed in claim 7, wherein the second protrusion is integrally formed with the housing.

10. An actuator as claimed in claim 4, wherein the first protrusion is connected by one of an interlocking, a frictional locking, a force locking, or a material locking connection.

11. An actuator as claimed in claim 1, wherein the toothed rack is axially slidably received within the first receptacle.

12. An actuator as claimed in claim 1, wherein the toothed rack is supported in bearings carried adjacent end areas of the first receptacle.

13. An actuator as claimed in claim 12, wherein the bearings are journal bearings that are carried by the first receptacle.

14. An actuator as claimed in claim 13, wherein one journal bearing defines a stop for the energy accumulator within the housing.
